(19) United States
(12) Patent Application Publication
(10) Pub. No.: US 2024/0278832 A1
(43) Pub. Date: Aug. 22, 2024

(54) VEHICLE CONTROL APPARATUS

(71) Applicant: Honda Motor Co., Ltd., Tokyo (JP)

(72) Inventors: Ken Sawada, Tokyo (JP); Yoshinori Izumi, Tokyo (JP); Yoshihiro Oniwa, Tokyo (JP)

(21) Appl. No.: 18/444,940

(22) Filed: Feb. 19, 2024

(30) Foreign Application Priority Data
Feb. 22, 2023 (JP) 2023-025798

(51) Int. Cl. B62D 15/02

(52) U.S. Cl. CPC B62D 15/025

(57) ABSTRACT

Vehicle control apparatus includes: external environment sensor configured to detect external environment situation including location of object in surrounding area of vehicle; and electronic control unit including processor and memory coupled to processor. The electronic control unit: recognizes external environment situation of vehicle based on signal from external environment sensor; calculates target steering angular velocity of steering assistance of vehicle based on external environment situation recognized; limits steering assistance by decreasing target steering angular velocity to limited steering angular velocity when duration exceeds predetermined duration, duration being period while target steering angular velocity calculated exceeds predetermined steering angular velocity; and limits steering assistance so that change amount of steering angle of vehicle from start of steering assistance is equal to or smaller than predetermined value.

### CROSS-REFERENCE TO RELATED APPLICATION

This application is based upon and claims the benefit of priority from Japanese Patent Application No. 2023-025798 filed on Feb. 22, 2023, the content of which is incorporated herein by reference.

### BACKGROUND OF THE INVENTION

### Field of the Invention

This invention relates to a vehicle control apparatus configured to perform steering assistance of a vehicle having an automatic driving function or a driving assistance function.

### Description of the Related Art

A device that performs steering assistance such as lane keeping and road departure mitigation has been conventionally known (for example, see JP 2017-061264 A). In the device described in JP 2017-061264 A, a first target steering angle is calculated, based on image information, a second target steering angle is calculated, based on host vehicle location information and map information, a target steering angle limit value and a target steering angular velocity limit value are calculated with the second target steering angle as a reference, the first target steering angle is limited by the target steering angle limit value and the target steering angular velocity limit value, and steering control is conducted at the first target steering angle that has been limited.

Vehicles having an automatic driving function and a driving assistance function are widely used, thus safety and convenience of the entire transportation society are improved, and a sustainable transportation system is achievable.

In the device described in JP 2017-061264 A, the steering angle and the steering angular velocity are limited, based on the map information. Hence, it is difficult to perform appropriate steering assistance, in a case where the map information does not exist or is not accurate.

### SUMMARY OF THE INVENTION

An aspect of the present invention is a vehicle control apparatus, including: an external environment sensor configured to detect an external environment situation including a location of an object in a surrounding area of a vehicle; and an electronic control unit including a processor and a memory coupled to the processor. The electronic control unit: recognizes the external environment situation of the vehicle based on a signal from the external environment sensor; calculates a target steering angular velocity of steering assistance of the vehicle based on the external environment situation recognized; limits the steering assistance by decreasing the target steering angular velocity to a limited steering angular velocity when a duration exceeds a predetermined duration, the duration being a period while the target steering angular velocity calculated exceeds a predetermined steering angular velocity; and limits the steering assistance so that a change amount of a steering angle of the vehicle from a start of the steering assistance is equal to or smaller than a predetermined value.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of main components of a vehicle control apparatus according to an embodiment of the present invention;

FIG. 2 is a time chart for describing limitation of steering assistance in a case where only target steering angular velocity is limited;

FIG. 3 is a time chart for describing a case where the limitation of the steering assistance that limits only the target steering angular velocity does not function;

FIG. 4 is a time chart for describing the limitation of the steering assistance by an assistance limitation unit of FIG. 1 for limiting the target steering angular velocity and change amount of steering angle;

FIG. 5 is a diagram for describing relationship between traveling speed of vehicle and excessive lateral movement amount;

FIG. 6 is a diagram for describing relationship between the traveling speed of the vehicle and threshold of the change amount of the steering angle; and

FIG. 7 is a flow chart illustrating an example of processing performed by the vehicle control apparatus according to the embodiment of the present invention.

### DETAILED DESCRIPTION OF THE INVENTION

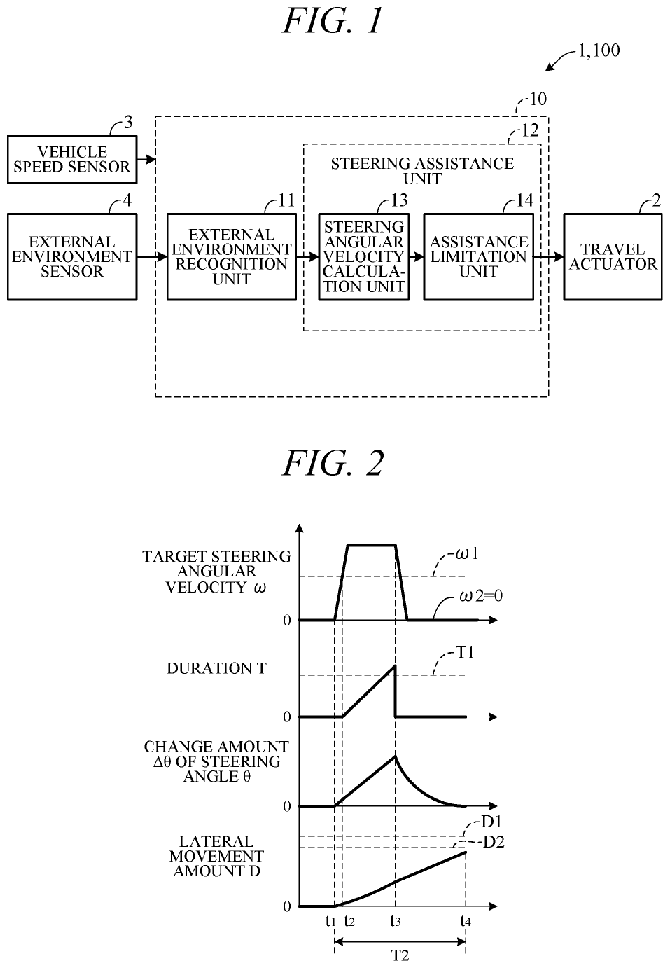

Hereinafter, embodiments of the present invention will be described with reference to FIGS. 1 to 7. A vehicle control device according to an embodiment of the present invention is applied to a vehicle having a driving assistance function of performing driving assistance including at least steering assistance for a driver of the vehicle or controlling a travel actuator to automatically drive the vehicle. The “driving assistance” in the present embodiment includes driving assistance for assisting a driving operation such as steering by a driver and automatic driving for automatically driving a vehicle regardless of the driving operation by the driver, and corresponds to automatic driving of levels 1 to 4 defined by SAE, and the “automatic driving” corresponds to automatic driving of level 5.

During driving assistance or automatic driving, steering assistance for controlling a turning mechanism of the vehicle is performed so that the vehicle travels in a traveling lane, based on a recognition result in the surroundings of the vehicle by a camera or the like. In the steering assistance, when it is determined that the vehicle has departed from the traveling lane or is departing from the traveling lane, based on the recognition result in the surroundings of the vehicle by the camera or the like, the turning mechanism is controlled so that the vehicle returns to the traveling lane.

However, if a behavior of the vehicle that is not intended by the driver occurs due to such steering assistance, the driver may feel uneasy or it may lead to an unexpected event depending on its degree. Therefore, in the present embodiment, a vehicle control device is configured as follows so as to perform appropriate steering assistance, while suppressing such a behavior of the vehicle.

FIG. 1 is a block diagram schematically illustrating an example of main components of a vehicle control device (hereinafter, a device) 100 according to an embodiment of the present invention. As illustrated in FIG. 1, the device 100 is mainly configured with an electronic control unit (ECU) 10. The ECU 10 includes a computer including a CPU (processor), a RAM and a ROM (memory), an I/O interface, and other peripheral circuits. The ECU 10 is configured as a part of a plurality of ECU groups that are mounted on, for example, the vehicle 1 and that control the operation of the vehicle 1.

A travel actuator 2, a vehicle speed sensor 3, and an external environment sensor 4, which are mounted on the vehicle 1, are connected with the ECU 10. The travel actuator 2 includes a turning mechanism such as a steering gear that turns the vehicle 1. The vehicle speed sensor 3 includes, for example, a wheel speed sensor that detects a rotational speed of a wheel, and detects a traveling speed V of the vehicle 1.

The external environment sensor 4 detects an external environment situation including a location of an object in a surrounding area of the vehicle 1. The external environment sensor 4 includes an imaging element such as a CCD or a CMOS, and includes a camera that images the surrounding area of the vehicle 1. The external environment sensor 4 may include a distance detection unit that detects a distance from the vehicle 1 to an object in the surrounding area. The distance detection unit includes, for example, a millimeter wave radar that emits a millimeter wave (radio wave) and that measures a distance and a direction to an object from a time until the emitted wave hits the object and returns. The distance detection unit may be constituted of a LiDAR that emits laser light and that measures a distance and a direction to an object from a time until the emitted light hits the object and returns.

The ECU 10 includes an external environment recognition unit 11 and a steering assistance unit 12 as functional configurations, and functions as the external environment recognition unit 11 and the steering assistance unit 12.

The external environment recognition unit 11 recognizes an external environment situation of a surrounding area with an advancing direction of the vehicle 1 as the center, based on signals from the external environment sensor 4. In particular, a lane marking, a curbstone, a guardrail, and the like on a road are recognized, so that a traveling lane in which the vehicle 1 is traveling is recognized. In addition, it is determined whether the vehicle 1 has departed from the traveling lane or whether the vehicle 1 is departing from the traveling lane, based on a recognition result.

The steering assistance unit 12 performs steering assistance of the vehicle 1, based on an external environment situation that has been recognized by the external environment recognition unit 11. In particular, when it is determined that the vehicle 1 has departed from the traveling lane or is departing therefrom, the steering assistance is performed by controlling the turning mechanism so that the vehicle 1 returns to the traveling lane, based on the external environment situation that has been recognized by the external environment recognition unit 11. The steering assistance unit 12 includes a steering angular velocity calculation unit 13 and an assistance limitation unit 14 as functional configurations, and functions as the steering angular velocity calculation unit 13 and the assistance limitation unit 14.

The steering angular velocity calculation unit 13 calculates a target steering angular velocity ω of the steering assistance by the steering assistance unit 12, based on a recognition result by the external environment recognition unit 11. The steering torque (assist torque) to be applied to the turning mechanism is calculated, based on the target steering angular velocity ω, which has been calculated by the steering angular velocity calculation unit 13, and the turning mechanism is controlled.

The assistance limitation unit 14 determines whether the target steering angular velocity ω, which has been calculated by the steering angular velocity calculation unit 13, exceeds a predetermined steering angular velocity ω1, which may make the driver feel uneasy or which may lead to an unexpected event, every predetermined arithmetic cycle. In a case where it is determined that the target steering angular velocity ω exceeds the predetermined steering angular velocity ω1, a duration T, which is a period of time while the target steering angular velocity ω exceeds the predetermined steering angular velocity ω1, is calculated. Then, it is determined whether the calculated duration T exceeds a predetermined duration T1, which can generate an excessive lateral movement amount D1, which may make the driver feel uneasy or which may lead to an unexpected event.

In a case where it is determined that the duration T exceeds the predetermined duration T1, the steering assistance by the steering assistance unit 12 is limited, by decreasing the target steering angular velocity ω to a limited steering angular velocity ω2 (target steering angular velocity limitation). The limited steering angular velocity ω2 is set to, for example, 0 [deg/sec]. In this case, the steering torque to be applied to the turning mechanism is set to 0 [Nm], and the steering assistance by the steering assistance unit 12 is stopped.

The assistance limitation unit 14 further calculates a change amount Δθ of a steering angle θ of the vehicle 1 every predetermined arithmetic cycle, from the start of the steering assistance by the steering assistance unit 12 to the lapse of a predetermined period T2, and limits the steering assistance by the steering assistance unit 12 so that the change amount Δθ that has been calculated becomes equal to or smaller than a predetermined value θ1 (target steering angle limitation). More specifically, a difference (|θ(tₙ)−θ(t₀)|) between a steering angle θ(t₀) at the start of the steering assistance and a target steering angle θ(tₙ) at a current arithmetic cycle is calculated as a change amount Δθ(tₙ), and it is determined whether the change amount Δθ(tₙ) that has been calculated is equal to or smaller than the predetermined value θ1. Then, in a case where it is determined that the change amount Δθ(tₙ) exceeds the predetermined value θ1, the target steering angle θ(tₙ) at the current arithmetic cycle is limited to either a value (θ(t₀)+θ1), which is obtained by adding the predetermined value θ1 to the steering angle θ(t₀) at the start of steering assistance, or a value (θ(t₀)−θ1), which is obtained by subtracting the predetermined value θ1 from the steering angle θ(t₀) at the start of steering assistance. In this case, feedback control is conducted such that the target steering angular velocity ω(tₙ) is calculated, based on the target steering angle θ(tₙ) that has been limited, the steering torque to be applied to the turning mechanism is calculated, based on the target steering angular velocity ω, which has been calculated by the steering angular velocity calculation unit 13, and the turning mechanism is controlled.

FIGS. 2 to 4 are time charts for describing the limitation of the steering assistance, and illustrate changes over time of the target steering angular velocity ω, the duration T, the change amount Δθ of the steering angle θ, and the lateral movement amount D of the vehicle 1 during the predetermined period T2, from the start of the steering assistance. The lateral movement amount D of the vehicle 1 is a movement distance of the vehicle 1 in a vehicle width direction orthogonal to the advancing direction of the vehicle 1.

FIG. 2 is a time chart for describing limitation of steering assistance in a case where only the target steering angular velocity ω is limited. As illustrated in FIG. 2, the steering assistance is started at time t₁, and when the target steering angular velocity ω exceeds the predetermined steering angular velocity ω1 at time t₂, the calculation of the duration T is started. Thereafter, when the duration T exceeds the predetermined duration T1 at time t₃, the target steering angular velocity ω is decreased to the limited steering angular velocity ω2 (ω2=0), the steering torque is not applied to the turning mechanism, and the steering assistance is stopped (target steering angular velocity limitation).

In this case, after time t₃, the steering angle θ gradually returns to an initial state (for example, 0 [deg] corresponding to a straight traveling state of the vehicle 1), and the increase in the lateral movement amount D becomes gentle. Thus, the lateral movement amount D at time t₄, that is, the lateral movement amount D in the predetermined period T2 in accordance with the steering assistance is suppressed. In a case where the steering assistance is limited by focusing only on the target steering angular velocity ω in this manner, the lateral movement amount D in the predetermined period T2 can be suppressed to be smaller than the excessive lateral movement amount D1, whereas there is a possibility that the lateral movement amount D2 necessary for performing appropriate steering assistance cannot be ensured.

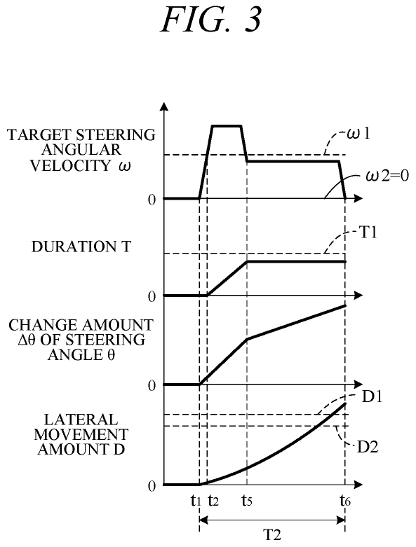

FIG. 3 is a time chart for describing a case where the limitation of the steering assistance that limits only the target steering angular velocity ω does not function. In a case where the traveling lane of the vehicle 1 in the advancing direction is recognized by using the external environment sensor 4 such as a camera, when the steering assistance is started and the vehicle 1 moves toward an inner side of the traveling lane, the line marking or the like that defines the traveling lane disappears from the angle of view of the external environment sensor 4, and the recognition accuracy of the traveling lane by the external environment recognition unit 11 may be lowered. Alternatively, the recognition accuracy of the traveling lane by the external environment recognition unit 11 may be lowered by discontinuity, deformation, or the like of the lane marking itself or the like.

In such a case, as illustrated in FIG. 3, after the steering assistance is started, the external environment recognition unit 11 may erroneously recognize the traveling lane at time t₅, and the target steering angular velocity ω may temporarily become lower than the predetermined steering angular velocity ω1. In this case, the duration T does not exceed the predetermined duration T1, and the target steering angular velocity ω is not limited. Hence, the steering assistance is continued, and there is a possibility that the lateral movement amount D at time t₆ in the predetermined period T2 from the start of the steering assistance exceeds the excessive lateral movement amount D1.

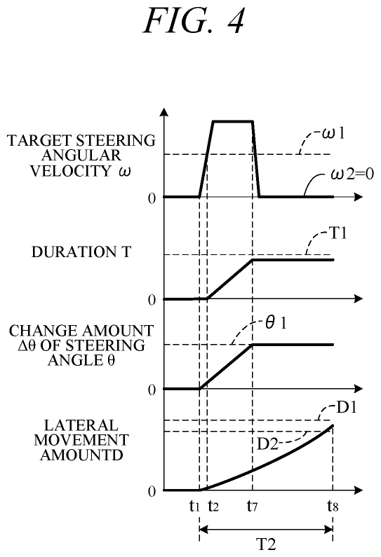

FIG. 4 is a time chart for describing the limitation of the steering assistance by the assistance limitation unit 14 of FIG. 1 for limiting the target steering angular velocity ω and the change amount Δθ of the steering angle θ. As illustrated in FIG. 4, when the steering assistance is started at time t₁, the target steering angular velocity ω exceeds the predetermined steering angular velocity ω1 at time t₂, and the calculation of the duration T is started. Then, when the change amount Δθ of the steering angle θ reaches the predetermined value θ1 at time t₇, the change amount Δθ of the steering angle θ is limited to the predetermined value θ1 (the target steering angle limitation).

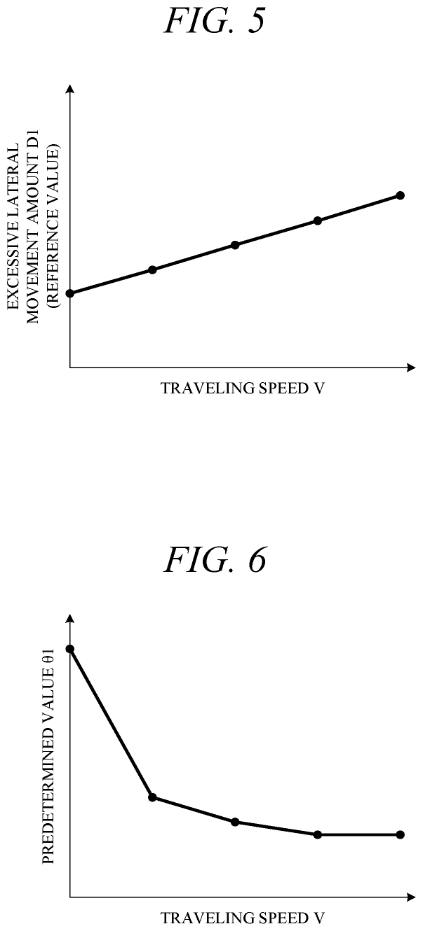

FIG. 5 is a diagram for describing a relationship between the traveling speed V of the vehicle 1 and the excessive lateral movement amount D1. As illustrated in FIG. 5, the excessive lateral movement amount D1 (a reference value), which may make the driver feel uneasy or which may lead to an unexpected event, is set to a larger value, as the traveling speed V is higher. Such a reference value can be defined by, for example, tests using the vehicle 1.

The lateral movement amount D of the vehicle 1 changes in accordance with the traveling speed V of the vehicle 1 and the change amount Δθ of the steering angle θ. The lateral movement amount D increases, as the change amount Δθ of the steering angle θ increases, even at an identical traveling speed V, and increases, as the traveling speed V increases, even at an identical change amount Δθ of the steering angle θ. Therefore, the predetermined value θ1, which is a threshold of the change amount Δθ of the steering angle θ, is set to an appropriate value in accordance with the traveling speed V, so that the lateral movement amount D during the limitation of the steering assistance in accordance with the target steering angle limitation can be suppressed, and the lateral movement amount D in the predetermined period T2 from the start of the steering assistance can be suppressed to be smaller than the excessive lateral movement amount D1.

FIG. 6 is a diagram for describing a relationship between the traveling speed V of the vehicle 1 and the predetermined value θ1, which is the threshold of the change amount Δθ of the steering angle θ. As illustrated in FIG. 6, the predetermined value θ1 is set to a smaller value, as the traveling speed V of the vehicle 1 increases, so that the lateral movement amount D of the vehicle 1 in the predetermined period T2 from the start of the steering assistance becomes smaller than the excessive lateral movement amount D1. In this manner, in a case where the predetermined value θ1 is set so that the lateral movement amount D in accordance with the steering assistance does not reach the excessive lateral movement amount D1, the duration T, in the period while the target steering angular velocity ω exceeds the predetermined steering angular velocity ω1, does not exceed the predetermined duration T1. Thus, the steering assistance is not stopped by the target steering angular velocity limitation.

In addition, the predetermined value θ1 is set to a sufficiently large value (for example, a maximum value) in a range in which the lateral movement amount D is smaller than the excessive lateral movement amount D1 in order to ensure the lateral movement amount D2 necessary for performing appropriate steering assistance. The predetermined value θ1 may be set to a value (for example, a minimum value) enough to ensure the necessary lateral movement amount D2, which is calculated, based on a recognition result by the external environment recognition unit 11. In this case, the lateral movement amount D of the vehicle 1 by the steering assistance is suppressed to the minimum.

As illustrated in FIG. 4, the steering assistance is not limited, until the change amount Δθ of the steering angle θ reaches the predetermined value θ1 at time t₇. Therefore, large steering torque corresponding to the target steering angular velocity ω is applied to the turning mechanism at an initial stage of the steering assistance, so that the vehicle 1 can be suppressed from departing or the like from the traveling lane promptly. In addition, also after the limitation of the steering assistance by the target steering angle limitation is started at time t₇, the feedback control of the turning mechanism is conducted, based on the target steering angle θ(tₙ) that has been limited in accordance with the predetermined value θ1, and the steering assistance is continued. Accordingly, it becomes possible to ensure the lateral movement amount D2, which is necessary in the predetermined period T2 from the start of the steering assistance, and it becomes possible to suppress the vehicle 1 from departing from the traveling lane and the like with certainty.

The limitation of the steering assistance by the target steering angle limitation is not performed, after the predetermined period T2 elapses. Therefore, after the predetermined period T2 elapses, only the steering assistance is limited in accordance with the target steering angular velocity limitation. Therefore, after the predetermined period T2 elapses, in a case where the target steering angular velocity ω to be calculated, based on a recognition result by the external environment recognition unit 11, exceeds the predetermined steering angular velocity ω1 and the duration T of such a period exceeds the predetermined duration T1, the steering assistance is limited (stopped) by the target steering angular velocity limitation.

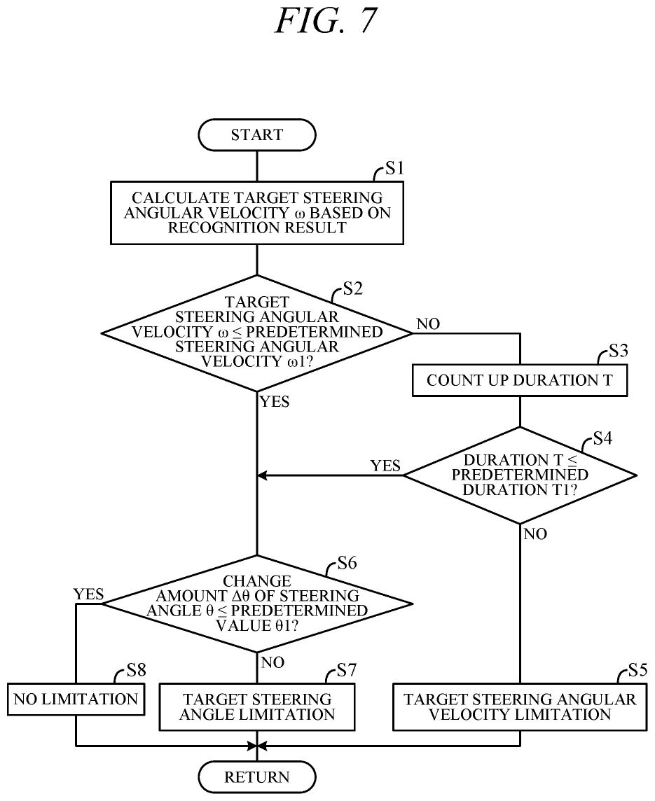

FIG. 7 is a flow chart illustrating an example of processing performed by the ECU 10 of the apparatus 100. The processing illustrated in the flowchart starts, for example, when the vehicle 1 starts up and the ECU 10 is activated, and is repeatedly performed at a predetermined arithmetic cycle Δt.

As illustrated in FIG. 7, first in S1 (S: processing step), the traveling lane is recognized based on signals from the external environment sensor 4, and then, based on the recognition result, the necessary lateral movement amount D2 and the target steering angular velocity ω are calculated. Next, in S2, it is determined whether the target steering angular velocity ω calculated in S1 is equal to or lower than the predetermined steering angular velocity ω1. When the determination is negative in S2, then in S3, the duration T(tₙ) is counted up (T(tₙ)=T(tₙ₋₁)+Δt), and then in S4, it is determined whether the duration T(tₙ) exceeds the predetermined duration T1. When the determination is negative in S4, then in S5, the steering assistance is limited or discontinued by the target steering angular velocity limitation.

On the other hand, when the determination is positive in S2 or S4, then in S6, the change amount Δθ(tₙ) of the steering angle θ is calculated (Δθ(tₙ)=|θ(tₙ)−θ(t₀)|) and then it is determined whether the calculated change amount Δθ(tₙ) of the steering angle θ is equal to or smaller than a predetermined value θ1. When the determination is negative in S6, then in S7, the steering assistance is limited by the target steering angle limitation. On the other hand, when the determination is positive in S6, then in S8, the steering assistance based on the target steering angular velocity ω calculated in S1 is performed (no limitation).

According to the present embodiment, the following operations and effects are achievable.

(1) The device 100 includes: the external environment recognition unit 11, which recognizes an external environment situation in a surrounding area of the vehicle 1; and the steering assistance unit 12, which performs steering assistance of the vehicle 1 (FIG. 1). The steering assistance unit 12 includes: the steering angular velocity calculation unit 13, which calculates the target steering angular velocity ω of the steering assistance by the steering assistance unit 12, based on the external environment situation that has been recognized by the external environment recognition unit 11; and the assistance limitation unit 14, which limits the steering assistance by the steering assistance unit 12 by decreasing the target steering angular velocity ω to the limited steering angular velocity ω2, when the duration T exceeds the predetermined duration T1, the duration T being a period while the target steering angular velocity ω that has been calculated by the steering angular velocity calculation unit 13 exceeds a predetermined steering angular velocity ω1 (S2 to S5 in FIGS. 1 and 7). The assistance limitation unit 14 further limits the steering assistance by the steering assistance unit 12 so that the change amount Δθ of the steering angle θ of the vehicle 1 from the start of the steering assistance by the steering assistance unit 12 becomes equal to or smaller than the predetermined value θ1 (S6 to S7 in FIG. 7).

The steering assistance is not limited, until the duration T, which is the period exceeding the predetermined steering angular velocity ω1, exceeds the predetermined duration T1 or until the change amount Δθ of the steering angle θ exceeds the predetermined value θ1. Therefore, it is possible to effectively perform the steering assistance at the initial stage of the steering assistance, while suppressing an excessive vehicle behavior. In addition, the steering assistance is limited by a simple configuration of monitoring the steering angle θ and the steering angular velocity ω of the vehicle 1, so that appropriate steering assistance can be performed, regardless of the presence or absence of external information such as the map information.

(2) The predetermined value θ1 is set so that the duration T does not to exceed the predetermined duration T1 (FIG. 4). In this case, the steering assistance is not stopped by the target steering angular velocity limitation at least during the predetermined period T2, and the necessary lateral movement amount D2 is ensured, so that appropriate steering assistance can be performed with certainty.

(3) The assistance limitation unit 14 limits the steering assistance by the steering assistance unit 12 so that the change amount Δθ from the start of the steering assistance by the steering assistance unit 12 to the lapse of the predetermined period T2 becomes equal to or smaller than the predetermined value θ1 (FIG. 4). Therefore, after the predetermined period T2 elapses, in a case where the target steering angular velocity ω to be calculated, based on a recognition result by the external environment recognition unit 11, exceeds the predetermined steering angular velocity ω1 and the duration T of such a period exceeds the predetermined duration T1, the steering assistance is limited (stopped) by the target steering angular velocity limitation. This enables suppression of an excessive vehicle behavior due to the steering assistance with certainty.

(4) The predetermined value θ1 is set to a smaller value, as the traveling speed V of the vehicle 1 increases (FIG. 6). The lateral movement amount D of the vehicle 1 in accordance with the steering assistance increases, as the traveling speed V increases. However, the predetermined value θ1 is set to an appropriate value in accordance with the traveling speed V, so that an excessive vehicle behavior due to the steering assistance can be suppressed with certainty, regardless of the traveling speed V.

(5) The limited steering angular velocity ω2 is zero (ω2=0). In this case, the steering assistance is stopped by the target steering angular velocity limitation, and thus an excessive vehicle behavior due to the steering assistance can be suppressed with more certainty.

In the above embodiments, the description has been given with regard to an example in which the steering assistance is performed, when it is determined that the vehicle 1 has departed from the traveling lane or is departing from the traveling lane, based on the recognition result of the external environment situation in the surrounding area of the vehicle 1. However, the steering assistance unit that performs the steering assistance of the vehicle is not limited to such an example. For example, when it is determined that the vehicle 1 has departed from the center of the traveling lane or is going to depart therefrom, the steering assistance may be performed. When it is determined that it is necessary to avoid an obstacle in the advancing direction of the vehicle 1, the steering assistance may be performed.

The above embodiment can be combined as desired with one or more of the aforesaid modifications. The modifications can also be combined with one another.

According to the present invention, it becomes possible to perform appropriate steering assistance regardless of the presence or absence of the map information.

Above, while the present invention has been described with reference to the preferred embodiments thereof, it will be understood, by those skilled in the art, that various changes and modifications may be made thereto without departing from the scope of the appended claims.

1. A vehicle control apparatus, comprising:
an external environment sensor configured to detect an external environment situation including a location of an object in a surrounding area of a vehicle; and
an electronic control unit including a processor and a memory coupled to the processor, wherein
the electronic control unit:
recognizes the external environment situation of the vehicle based on a signal from the external environment sensor;
calculates a target steering angular velocity of steering assistance of the vehicle based on the external environment situation recognized;
limits the steering assistance by decreasing the target steering angular velocity to a limited steering angular velocity when a duration exceeds a predetermined duration, the duration being a period while the target steering angular velocity calculated exceeds a predetermined steering angular velocity; and
limits the steering assistance so that a change amount of a steering angle of the vehicle from a start of the steering assistance is equal to or smaller than a predetermined value.

2. The vehicle control apparatus according to claim 1, wherein
the predetermined value is set so that the duration does not to exceed the predetermined duration.

3. The vehicle control apparatus according to claim 1, wherein
the electronic control unit limits the steering assistance so that the change amount from the start of the steering assistance until a predetermined period has elapsed is equal to or smaller than the predetermined value.

4. The vehicle control apparatus according to claim 2, wherein
the predetermined value is set to a smaller value as a traveling speed of the vehicle increases.

5. The vehicle control apparatus according to claim 1, wherein
the limited steering angular velocity is zero.

6. The vehicle control apparatus according to claim 1, wherein
the external environment sensor includes at least one of a camera, a millimeter wave radar, and a LiDAR, wherein
the electronic control unit recognizes the external environment situation in the surrounding area with an advancing direction of the vehicle as a center based on the signal from the external environment sensor.

7. The vehicle control apparatus according to claim 1, wherein
the electronic control unit:
recognizes a traveling lane in which the vehicle travels; and
performs the steering assistance of the vehicle by controlling a turning mechanism of the vehicle so that the vehicle travels in the traveling lane based on the external environment situation when it is determined that the vehicle has departed from the traveling lane or is departing from the traveling lane based on a recognition result.

8. The vehicle control apparatus according to claim 7, wherein
in the steering assistance, a steering torque to be applied to the turning mechanism is calculated based on the target steering angular velocity, and the steering torque calculated is applied to the turning mechanism.

9. The vehicle control apparatus according to claim 1, wherein
the electronic control unit:
determines whether the change amount is equal to or smaller than the predetermined value;
limits a target steering angle of the steering assistance to a value obtained by adding a predetermined steering angle to or subtracting the predetermined steering angle from a steering angle of the vehicle at the start of the steering assistance, when it is determined that the change amount exceeds the predetermined value; and
calculates the target steering angular velocity based on the target steering angle limited.
